(19) United States
(12) Patent Application Publication
(10) Pub. No.: US 2025/0239642 A1
(43) Pub. Date: Jul. 24, 2025

(54) SECONDARY BATTERY AND SECONDARY BATTERY MANUFACTURING METHOD

(71) Applicant: SK On Co., Ltd., Seoul (KR)

(72) Inventor: Jae Myoung LEE, Daejeon (KR)

(21) Appl. No.: 18/985,047

(22) Filed: Dec. 18, 2024

(30) Foreign Application Priority Data
Jan. 18, 2024 (KR) 10-2024-0008106
May 24, 2024 (KR) 10-2024-0067976

(51) Int. Cl. H01M 10/04; H01M 50/107; H01M 50/536

(52) U.S. Cl. CPC H01M 10/0431; H01M 10/0481; H01M 50/107; H01M 50/536

(57) ABSTRACT

According to an embodiment of the present disclosure, Provided is a secondary battery comprising: an electrode assembly including a protruding region in which an uncoated portion protrudes and a non-protruding region in which the uncoated portion does not protrude, in an upper portion thereof; a current collector coupled to the protruding region and electrically connected to the electrode assembly; and a case accommodating the electrode assembly, wherein the electrode assembly includes a groove portion formed by bending at least a portion of the protruding region, wherein the current collector includes a protruding portion inserted into the groove portion, and wherein the non-protruding region includes an inner non-protruding region disposed further inwardly than the protruding region and an outer non-protruding region disposed further outwardly than the protruding region, in a central direction toward a winding axis along which the electrode assembly is wound.

### CROSS-REFERENCE TO RELATED APPLICATION(S)

This patent document claims the priority and benefits of Korean Patent Application Nos. 10-2024-0008106 and 10-2024-0067976 filed on Jan. 18, 2024, and May 24, 2024, the disclosures of which are incorporated herein by reference in their entirety.

### TECHNICAL FIELD

The disclosure and implementations disclosed in this patent document generally relate to a secondary battery and a secondary battery manufacturing method.

### BACKGROUND

Secondary batteries are one type of energy storage device that may be charged and discharged. Secondary batteries are widely used in various devices using electricity as a power source. For example, secondary batteries are used as energy storage devices in various means ranging from small devices such as mobile phones, laptop computers, and tablets to large devices such as vehicles and aircraft. Specifically, secondary batteries have been actively explored as a vehicle power source recently.

Secondary batteries may be classified into lead-acid batteries, nickel-cadmium batteries, nickel-hydrogen batteries, and lithium-ion batteries depending on the material of the electrode. Each type of secondary battery may be appropriately selected depending on the design capacity, usage environments, or the like. Alternatively, the secondary batteries may be an all-solid-state battery that uses a solid electrolyte instead of a liquid electrolyte. Lithium-ion batteries may implement relatively high voltage and capacity as compared to other types of secondary batteries. Accordingly, the lithium-ion batteries are widely used in fields that requiring high-density energy storage devices such as vehicle battery packs.

The secondary batteries such as lithium-ion batteries may include a positive electrode plate, a negative electrode plate, a separator, and an electrolyte. The positive electrode plate and the negative electrode plate are disposed with a separator formed of insulating material interposed therebetween, and may performed charging or discharging by the movement of ions through the electrolyte.

Secondary batteries are manufactured as flexible pouch-type battery cells or rigid square or cylindrical can-type battery cells.

### SUMMARY

According to an aspect of the present disclosure, a process of a secondary battery may be improved.

According to an aspect of the present disclosure, defects caused by foreign substances in a secondary battery may be reduced.

A secondary battery and a secondary battery manufacturing method of the present disclosure may be widely applied in green technology fields such as electric vehicles and battery charging stations. Additionally, the secondary battery and the secondary battery manufacturing method of the present disclosure may be used in eco-friendly electric vehicles, hybrid vehicles, or the like, to prevent climate change by suppressing air pollution and greenhouse gas emissions.

A secondary battery according to the present disclosure may include: an electrode assembly in which a positive electrode, a negative electrode and a separator are wound and formed, and which includes a protruding region in which an uncoated portion protrudes and a non-protruding region in which the uncoated portion does not protrude, in an upper portion thereof; a current collector coupled to the protruding region and electrically connected to the electrode assembly; and a case accommodating the electrode assembly, and the electrode assembly may include a groove portion formed by bending at least a portion of the protruding region, the current collector may include a protruding portion inserted into the groove portion, and the non-protruding region may include an inner non-protruding region disposed further inwardly than the protruding region and an outer non-protruding region disposed further outwardly than the protruding region, in a central direction toward a winding axis along which the electrode assembly is wound.

In an embodiment, the groove portion may be formed by pressing at least a portion of the protruding region in the central direction.

In an embodiment, a width of the groove portion may be formed to decrease toward the center direction.

In an embodiment, a width of the groove portion may be formed to be constant.

In an embodiment, the electrode assembly may have a first hole formed in the center thereof, in which the positive electrode, the negative electrode, and the separator are not disposed.

In an embodiment, at least a portion of the groove portion may be bent and disposed in an upper portion of the inner non-protruding region and may not be disposed on the first hole.

In an embodiment, the current collector may include a plurality of second holes spaced apart from each other in the center.

In an embodiment, the current collector may include a current collecting pillar protruding from the center.

In an embodiment, the groove portion and the protruding portion may be formed in plural.

In an embodiment, a width, a difference between an outer diameter and an inner diameter of the inner non-protruding region, may be equal to or less than a height of the uncoated portion of the protruding region.

A secondary battery manufacturing method according to the present disclosure may include: a preparation operation of preparing an electrode assembly in which a positive electrode, a negative electrode and a separator are wound and formed, and which includes a protruding region in which an uncoated portion protrudes and a non-protruding region in which the uncoated portion does not protrude, in an upper portion thereof; a pressing operation of forming a groove portion by bending at least a portion of the protruding region; an assembling operation of assembling the current collector and the electrode assembly so that the protruding portion of the current collector is inserted into the groove portion; and a welding operation of welding a region of the protruding portion.

In an embodiment, the pressing operation may be an operation of pressing at least a portion of the protruding region in a central direction toward a winding axis along which the electrode assembly is wound.

In an embodiment, the welding operation may be an operation of welding the current collector by irradiating a laser to an upper portion of the current collector assembled in the assembling operation.

According to an embodiment of the present disclosure, a process of a secondary battery may be improved.

According to an embodiment of the present disclosure, defects caused by foreign substances in the secondary battery may be reduced.

### BRIEF DESCRIPTION OF DRAWINGS

Certain aspects, features, and advantages of the present disclosure are illustrated by the following detailed description with reference to the accompanying drawings.

FIG. 1 is an exploded perspective view illustrating a secondary battery.

FIG. 2 is a plan view illustrating an upper portion of the electrode assembly.

FIG. 3 is a plan view illustrating an upper portion of an electrode assembly according to a modified embodiment.

FIG. 4 is a cross-sectional view taken along line I-I′ of FIG. 2.

FIG. 5 is a cross-sectional view taken along line II-II′ of FIG. 2.

FIG. 6 is a cross-sectional view taken along line I-I′ of FIG. 2.

FIG. 7 is a bottom view illustrating a lower portion of a current collector.

FIG. 8 is a side view illustrating a side surface of a current collector.

FIG. 9 is a side view illustrating a side surface of a current collector according to a modified embodiment.

FIG. 10 is a flowchart illustrating a manufacturing method of a secondary battery.

### DETAILED DESCRIPTION

Hereinafter, embodiments of the present disclosure will be described with reference to the attached drawings. For convenience, in the following description, detailed descriptions of components that may obscure the technical gist of the present disclosure or well-known components will be omitted.

The following embodiments are provided to more fully explain the present disclosure to those skilled in the art. The following embodiments are provided to help understand the present disclosure, and the technical idea of the present disclosure is not necessarily limited to the specific embodiments described below. It should be understood that the present disclosure broadly includes various kinds of equivalents, substitutes and conversions, which implement the technical idea described in the following embodiments.

The terms used in the following embodiments are provided to more fully explain the specific embodiments from the above-stated perspective. Accordingly, the terms used in the following embodiments should not be construed as reducing, limiting, or restricting the technical concept of the present disclosure.

In the following description, the singular may be interpreted to include the plural unless specifically stated otherwise in the phrase. Furthermore, “comprises,” “comprising,” “includes,” “including,” “has” and/or “having” when used herein, specify the presence of stated features, components, parts, operations, features, steps, and/or numbers, but do not preclude the presence or addition of one or more other components, parts, operations, features, steps, and/or numbers thereof.

A secondary battery or a battery cell described in this specification may encompass a rechargeable battery. For example, the secondary battery may include a lead-acid battery, a nickel-cadmium battery, a nickel-hydrogen battery, and a lithium-ion battery. This description mainly assumes that the secondary battery is a lithium-ion battery. However, it should be understood that the technical concepts described in this specification may be applied to other suitable types of batteries in addition to lithium-ion batteries.

Prior to describing the exemplary embodiments in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation. Therefore, it should be understood that the embodiments described in this specification and the configurations illustrated in the drawings are only the most desirable embodiments of the disclosed technology and do not represent all the technical concepts of disclosed technology, and accordingly, there may be various equivalents and variations that may replace the embodiments and the configurations of the disclosed technology at the time of this application.

Hereinafter, with reference to the drawings, specific embodiments of the present disclosure will be described. In this case, it should be noted that in the attached drawings, identical components are indicated by identical symbols whenever possible. Additionally, detailed descriptions of well-known functions and configurations that may obscure the gist of the present disclosure will be omitted. For the same reason, some components are exaggerated, omitted, or schematically depicted in the accompanying drawings, and the size of each component does not entirely reflect its actual size. For example, in this specification, the expressions such as “above,” “upper,” “upward,” “below”, “beneath,” “lower,” “downward,” “side,” and the like, are based on the direction illustrated in the drawings, and may be expressed differently if the direction of the object is changed.

Hereinafter, a secondary battery and a secondary battery manufacturing method according to the present disclosure will be described in detail with reference to the drawings.

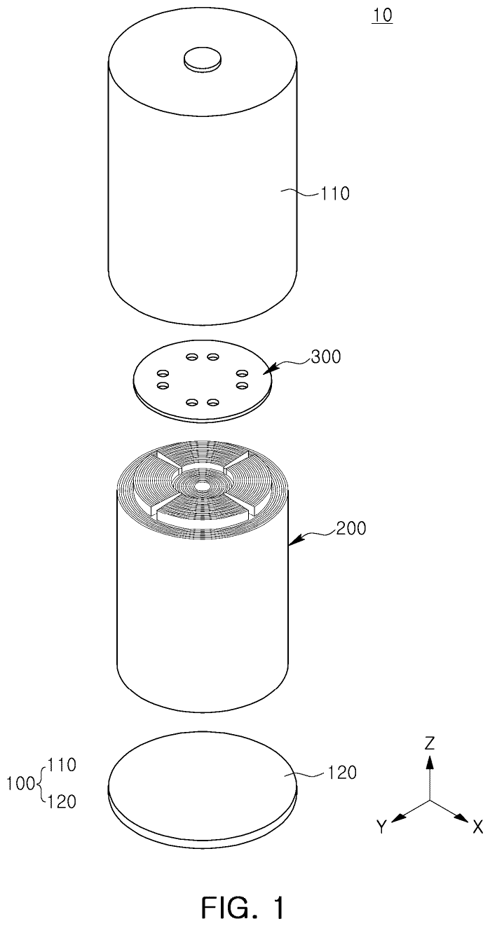

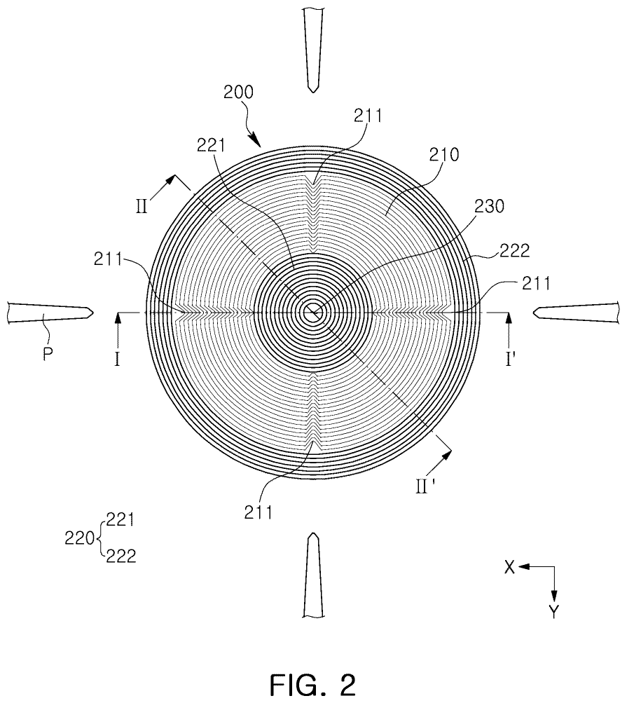

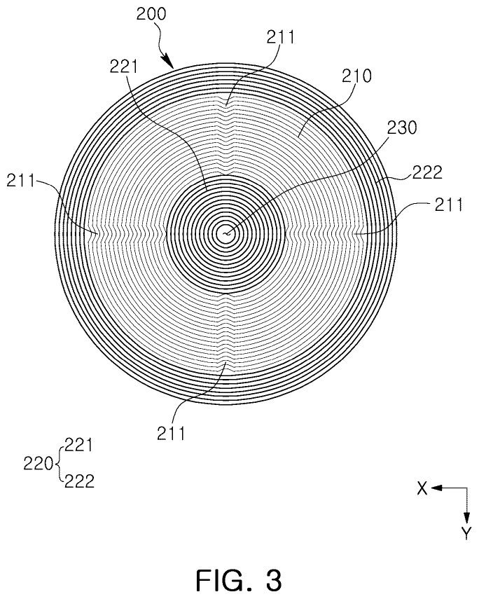

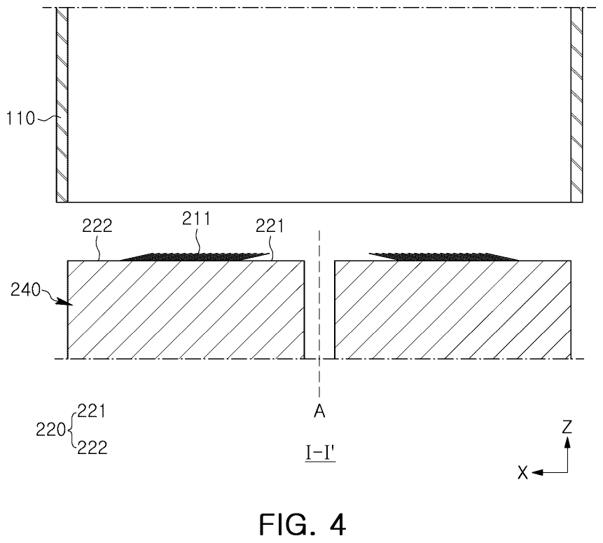

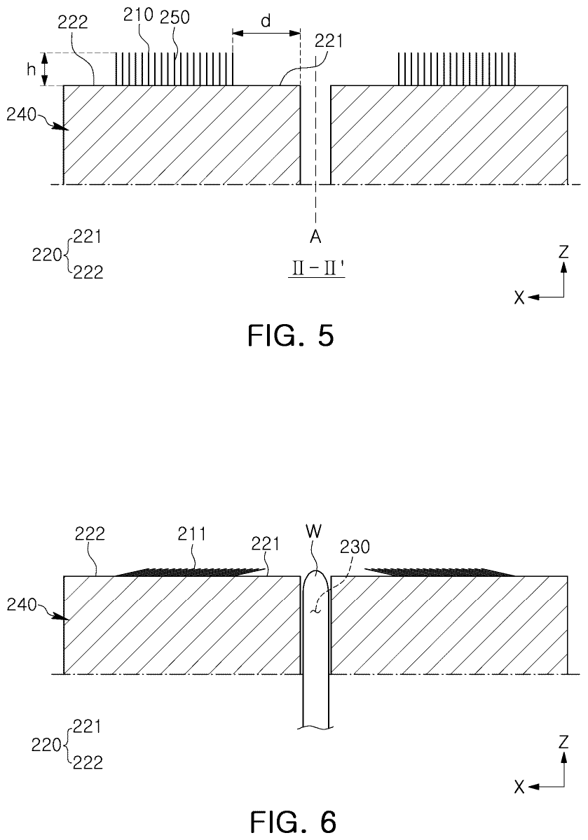

FIG. 1 is an exploded perspective view of a secondary battery 10, FIG. 2 is a plan view of an upper portion of an electrode assembly 200, FIG. 3 is a plan view illustrating an upper portion of an electrode assembly 200 according to a modified embodiment, FIG. 4 is a cross-sectional view taken along line I-I′ of FIG. 2, FIG. 5 is a cross-sectional view taken along line II-II′ of FIG. 2, and FIG. 6 is a cross-sectional view taken along line I-I′ of FIG. 2.

FIG. 2 illustrates a portion of a process of forming a groove portion 211 on an upper portion of an electrode assembly 200 in a process of manufacturing a secondary battery 10, and FIG. 3 illustrates a groove portion 211 having another shape. FIG. 4 illustrates a process in which an electrode assembly 200 is inserted into a case 100. FIG. 6 illustrates a state in which a welding rod W is inserted from a lower portion of a first hole 230 of an electrode assembly 200 in a process of manufacturing a secondary battery 10.

Referring to FIGS. 1 to 6, a secondary battery 10 according to the present disclosure may include an electrode assembly 200 and a case 100.

The case 100 may accommodate the electrode assembly 200.

The case 100 may be known as a can in other words. The case 100 may be formed to include an empty space therein to accommodate the electrode assembly 200. The case 100 may include a cylindrical shape or a columnar shape. Accordingly, the case 100 having a cylindrical shape or a columnar shape may include an empty space having a cylindrical shape or a columnar shape therein, and the electrode assembly 200 may be accommodated in the empty space. The case 100 may include a material having electrical conductivity. For example, examples of the material may include nickel-plated steel, stainless steel, and aluminum.

The case 100 may include a body portion 110 and a cap 120.

The body portion 110 may be a structure in which at least one of an upper portion and a lower portion thereof is open. That is, the body portion 110 may have at least one of an upper surface and a lower surface open. The body portion 110 may have a form in which both the upper portion and the lower portion are open, or may have a form in which the lower portion is open, or may have a form in which the upper portion is open. The electrode assembly 200 may be inserted into an interior of the case 100 through the open upper surface or lower surface. The body portion 110 may have various shapes. For example, the body portion 110 may include a cylindrical shape or a columnar shape. Referring to FIG. 1, the body portion 110 in the present disclosure is illustrated as having, for example, a cylindrical shape in which the lower surface is open.

The cap 120 may seal the open lower surface of the body portion 110. For example, the cap 120 may be coupled with the body portion 110 in the lower portion of the body portion 110 to seal the open lower portion of the body portion 110. A method of sealing the lower portion of the body portion 110 may be applied in various manner. For example, the body portion 110 and the cap 120 may be welded. Various welding methods may be applied for welding. For example, a laser welding method may be applied. An edge of the cap 120 may be welded while being coupled to the body portion 110.

The electrode assembly 200 may include a positive electrode, a negative electrode, and a separator. In the electrode assembly 200, the positive electrode, the negative electrode, and the separator may be wound and formed. The separator may be formed of an insulator interposed between the negative electrode and the positive electrode. The electrode assembly 200 may be configured in a stack type in which the positive electrode, the negative electrode, and the separator are alternately stacked. Alternatively, the electrode assembly 200 may be configured in a jelly roll type in which the positive electrode, the negative electrode, and the separator interposed between the positive electrode and the negative electrode are alternately stacked and wound in a roll shape. In the present disclosure, the electrode assembly 200 is illustrated as having a jelly roll type, but the present disclosure is not necessarily limited thereto.

Each of the positive electrode and the negative electrode may have a structure in which a positive electrode active material or a negative electrode active material is coated on a foil. For example, the negative electrode may be formed by coating graphite or the like on a copper or nickel material foil, and the positive electrode may be formed by coating a transition metal oxide active material on an aluminum material foil.

At least a portion of the positive electrode and the negative electrode may not be coated with an active material. A portion of the positive electrode and the negative electrode in which the active material is not coated may be referred to as an uncoated portion 250, respectively.

The electrode assembly 200 may include a protruding region 210 in which the uncoated portion 250 protrudes, and a non-protruding region 220 in which the uncoated portion 250 does not protrude, in an upper portion thereof. The uncoated portion 250 may be present on an upper portion of the foil before the foil is wound. In this case, the uncoated portion 250 may correspond to either the positive electrode or the negative electrode. An uncoated portion 250 corresponding to an opposite electrode may be disposed in the lower portion of the electrode assembly 200. After removing a certain region of the corresponding uncoated portion 250, the electrode plate may be wound to form the electrode assembly 200. In this case, after the winding, a region in which the uncoated portion 250 remains in a protruding state in the upper portion of the electrode assembly 200 may be the protruding region 210, and a region from which the uncoated portion 250 is removed may be the non-protruding region 220. The upper portion of the electrode assembly 200 may be divided into the protruding region 210 and the non-protruding region 220, and the protruding region 210 may protrude further upward than the non-protruding region 220. A retaining portion 240 may be disposed below the protruding region 210 and the non-protruding region 220. The retaining portion 240 may be a portion including a foil coated with an active material.

The electrode assembly 200 may include a groove portion 211 formed by bending at least a portion of the protruding region 210. The groove portion 211 may be a portion formed by bending and pressing a portion of the protruding uncoated portion 250. Accordingly, the groove portion 211 may include a shape that is recessed downwards as compared to other portions of the protruding region 210.

The groove portion 211 may be formed by pressing at least a portion of the protruding region 210 in a center direction. The center direction used here may be a direction toward a winding axis A along which the electrode assembly 200 is wound. In other words, the center direction may be a direction toward the first hole 230 formed in the center of the electrode assembly 200. Referring to FIG. 2, in order to form the groove portion 211, there may be a pressing means P for pressing the protruding region 210. The pressing means P may move from the outside of the electrode assembly 200 in the center direction and may pressurize the protruding region 210. The uncoated portion 250 may be tilted and bent in the center direction by the pressing means P. Referring to FIG. 4, the groove portion 211 may be tilted in the center direction.

A width of the groove portion 211 may be formed to decrease toward the center direction. Referring to FIG. 2, the groove portion 211 may be formed so that the width thereof decreases from the outside to the inside of the electrode assembly 200. The width of the groove portion 211 may refer to a breadth of the groove portion 211 when viewed from above. In order to form the groove portion 211 having a narrowing shape, the pressing means P may also include a shape having a thinner thickness toward a front surface thereof in response thereto.

The width of the groove portion 211 may be formed to be constant. Referring to FIG. 3, the groove portion 211 may be formed to have a constant width from the outside to the inside of the electrode assembly 200.

The groove portion 211 may be formed in plural, and the protruding portion 310 may also be formed in plural. For example, a plurality of groove portions 211 may be formed to be spaced apart from each other by a constant interval based on the winding axis A, and a plurality of protruding portions 310 inserted into the groove portions 211 may also be formed in positions corresponding thereto.

The shape and width of the groove portion 211 illustrated in FIGS. 2 and 3 are only examples. Accordingly, the present disclosure is not limited thereto and shape and width of the groove portion 211 may be appropriately modified as needed. For example, the groove portion 211 having a shape in which a width thereof increases toward inwardly, contrary to the groove portion 211 of FIG. 2, may also be provided. The groove portion 211 may provide a space for inserting the protruding portion 310 of a current collector 300 described below, and may increase an area welded with the current collector 300. Accordingly, the shape of the groove portion 211 may be appropriately modified in a range for achieving the purpose of the present disclosure.

Since the groove portion 211 is formed by bending the uncoated portion 250 without cutting the uncoated portion 250, foreign substances may not be generated during a process of forming the groove portion 211. When the groove portion 211 is cut and formed, a small amount of metal fragments may be generated in the cut portion, and the corresponding metal fragments may travel around the inside of the secondary battery 10 and may cause an electrical short circuit or may reduce the efficiency of the battery. Accordingly, the secondary battery 10 of the present disclosure may not generate such foreign substances.

The non-protruding region 220 may include an inner non-protruding region 221 and an outer non-protruding region 222. Specifically, the non-protruding region 220 may include the inner non-protruding region 221 disposed further inwardly than the protruding region 210 in the center direction, and the outer non-protruding region 222 disposed further outwardly than the protruding region 210. Referring to FIG. 2, the non-protruding region 220s may be formed on an outer side and an inner side of the protruding region 210, respectively. The non-protruding region 220 disposed outside of the protruding region 210 may be the outer non-protruding region 222. Conversely, the non-protruding region 220 disposed inside of the protruding region 210 may be the inner non-protruding region 221. Accordingly, the outer non-protruding region 222, the protruding region 210, and the inner non-protruding region 221 may be disposed in order from the outside to the inside.

Due to the formation of the outer non-protruding region 222, the electrode assembly 200 may prevent the uncoated portion 250 from being deformed by collision with the case 100 during a process in which the electrode assembly 200 is inserted into the case 100. Referring to FIG. 4, when the electrode assembly 200 is inserted upwardly through the open lower portion of the case 100, the body portion 110 of the case 100 and the uncoated portion 250 in the upper portion may collide with each other. Due to the collision of the uncoated portion 250, defects may occur during the manufacturing process, and due to the deformation of the uncoated portion 250, defects in the contact with the current collector 300 may occur. Accordingly, the possibility of the collision of the uncoated portion 250 and the case 100 may be reduced by forming the outer non-protruding region 222.

Additionally, due to the formation of the outer non-protruding region 222, the electrical connection between the uncoated portion 250 and the case 100 may be prevented after the electrode assembly 200 is inserted into the case 100. For example, when the uncoated portion 250 in the upper portion is the positive electrode, the case 100 may be connected to the negative electrode of the electrode assembly 200. Accordingly, when the uncoated portion 250 of the positive electrode comes into contact with the case 100 of the negative electrode, an electrical short circuit may occur. Since the outer non-protruding region 222 is disposed on the outside of the uncoated portion 250, the outer non-protruding region 222 may reduce the possibility of contact between the case 100 and the uncoated portion 250.

The electrode assembly 200 may have a first hole 230 formed in the center thereof, in which the positive electrode, the negative electrode, and separator are not disposed. In other words, a hole formed in a direction of an axis may be disposed on the winding axis A of the electrode assembly 200. The first hole 230 may be formed to be long in an axial direction of the electrode assembly 200.

In the manufacturing process of the secondary battery 10, a welding rod W may be inserted to weld an electrode terminal of an upper portion. Additionally, an electrolyte may be injected through the first hole 230. Referring to FIG. 6, the welding rod W may be inserted from a lower portion through the first hole 230. The inserted welding rod W may weld the electrode terminal of the upper portion and may then exit to the lower portion again. Accordingly, when the first hole 230 is blocked by another component, a movement path of the welding rod W may be obstructed during the manufacturing process of the secondary battery 10, which may cause manufacturing defects.

The uncoated portion 250 may be bent in a direction toward the first hole 230 during a process of forming the groove portion 211. In this case, due to the formation of the inner non-protruding region 221, the groove portion 211 may not be disposed on a path of the first hole 230. That is, at least a portion of the groove portion 211 may be bent and disposed above the inner non-protruding region 221, but may not be disposed on the first hole 230.

To this end, referring to FIG. 5, a width d, a difference between an outer diameter and an inner diameter of the inner non-protruding region 221, may be equal to or greater than a height h of the uncoated portion 250 of the protruding region 210. When the height h of the uncoated portion 250 is longer than the width d of the inner non-protruding region 221, a portion of the groove portion 211 may be bent and may cover at least a portion of the first hole 230. Accordingly, in order to prevent covering a portion of the first hole 230, the height h of the uncoated portion 250 or the width d of the inner non-protruding region 221 may be mutually appropriately limited. Alternatively, a bending angle of the uncoated portion 250 may be reduced in the process of forming the groove portion 211.

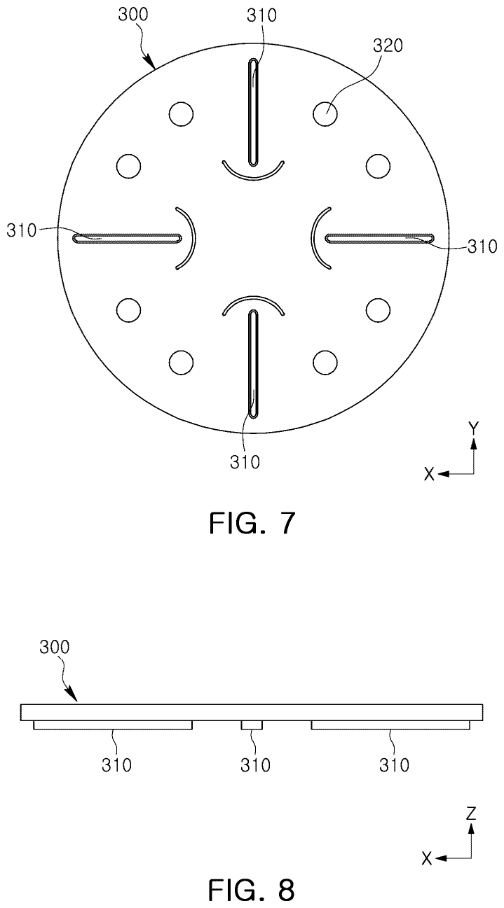

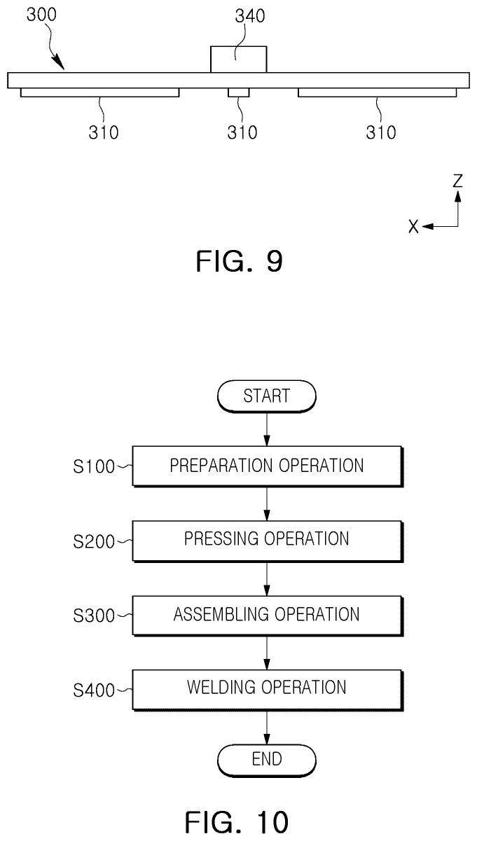

FIG. 7 is a bottom view illustrating a lower portion of a current collector 300, FIG. 8 is a side view illustrating a side surface of the current collector 300, and FIG. 9 is a side view illustrating the side surface of the current collector 300 according to a modified embodiment.

Referring to FIGS. 7 to 9 and FIGS. 1 to 6 together, the secondary battery 10 may include a current collector 300.

The current collector 300 may be coupled to the protruding region 210 and may be electrically connected to the electrode assembly 200. The current collector 300 may be coupled to the protruding region 210 disposed in the upper portion of the electrode assembly 200, and may be accommodated in the case 100. The electrode assembly 200 may be formed of an electrically conductive material, and the current collector 300 may be coupled to the protruding region 210 and may be electrically connected to the positive electrode or the negative electrode of the electrode assembly 200. For example, the current collector 300 may be welded to the protruding region 210, and may be electrically connected to the positive electrode of the electrode assembly 200.

The current collector 300 may be a disc-shaped plate. The current collector 300 may include a plurality of second holes 320 formed to be spaced apart from each other by a predetermined interval in the center thereof. An electrolyte may be smoothly injected into the upper portion of the electrode assembly 200 through the plurality of second holes 320.

The current collector 300 may include a protruding portion 310 inserted into the groove portion 211. The protruding portion 310 may be formed to protrude downwardly from the lower portion of the plate of the current collector 300. The protruding portion 310 may be formed in a position corresponding to the groove portion 211 so as to be inserted into the groove portion 211.

The current collector 300 may be stably coupled to the protrusion region 210 by inserting the protruding portion 310 into the groove portion 211. For example, the protruding portion 310 may be inserted into the groove portion 211 so that the current collector 300 and the protrusion region 210 are not misaligned. Additionally, a welding area may be expanded by an area in which the protruding portion 310 is inserted. In a state in which the protruding portion 310 is inserted into the groove portion 211, an upper portion of the current collector 300 in which the protruding portion 310 is disposed may be welded.

As illustrated in FIG. 9, the current collector 300 may further include a protruding current collecting pillar 340. For example, the current collecting pillar 340 may be a cylindrical column protruding upwardly from the center of the collector 300, and a hollow space may be formed therein. The current collecting pillar 340 may be formed to increase the bonding strength with an external terminal omitted in the present disclosure.

FIG. 10 is a flow chart illustrating a method for manufacturing an arch cell.

Referring to FIG. 10 and FIGS. 1 to 9 together, a method for manufacturing a secondary battery 10 may include a preparation operation (S100), a pressing operation (S200), an assembling operation (S300), and a welding operation (S400).

The preparation operation (S100) may be an operation for preparing an electrode assembly 200 in which a positive electrode, a negative electrode and a separator are wound and formed, and which includes a protruding region 210 in which an uncoated portion 250 protrudes and a non-protruding region 220 in which the uncoated portion 250 does not protrude, in an upper portion thereof. The configuration of the electrode assembly 200 prepared in the preparation operation (S100) may be the same as or similar to the configuration of the electrode assembly 200 described above.

The pressing operation (S200) may be an operation of forming a groove portion 211 by bending at least a portion of the protruding region 210. For example, at least a portion of the protruding region 210 may be pressed using a pressing means P. In this case, the uncoated portion 250 may be pressed and bent. Specifically, at least a portion of the protruding region 210 may be pressed in a central direction toward the winding axis A on which the electrode assembly 200 is wound, using the pressing means P. Referring to FIG. 2, the pressing means P may pressurize the protruding region 210 by moving from the outside of the electrode assembly 200 toward the center thereof, the inside thereof.

The assembling operation (S300) may be an operation of assembling a current collector 300 and the electrode assembly 200 so that a protruding portion 310 of the current collector 300 is inserted into the groove portion 211. For example, after adjusting the position of the current collector 300 so that the protruding portion 310 is inserted into the groove portion 211, the current collector 300 may be seated on an upper portion of the electrode assembly 200. In this case, the current collector 300 may be seated on an upper portion of the protrusion region 210.

The welding operation (S400) may be an operation of welding a region of the protruding portion 310. For example, the current collector 300 seated on the upper portion of the protrusion region 210 may be welded to the protrusion region 210. The region of the protruding portion 310 mentioned here may refer to an upper portion of the current collector 300 corresponding to a portion in which the protruding portion 310 is disposed. Various welding methods may be applied for welding, and one of welding methods may be a laser welding method. For example, a laser may be irradiated on the upper portion of the current collector 300 assembled in the assembling operation (S300) to weld the current collector 300 and the protrusion region 210. In this case, a position in which the laser is irradiated may be a region of the protruding portion 310.

In addition to the operations described above, the method for manufacturing a secondary battery 10 may include operations necessary for manufacturing a secondary battery 10, for example, an operation of inserting the electrode assembly 200 into the case 100, an operation of welding the cap 120 and the body portion 110 to seal the case 100, and an operation of injecting an electrolyte into the sealed case 100.

Although the embodiments of the present disclosure have been described in detail above, the scope of the present disclosure is not limited thereto, and it will be apparent to those skilled in the art that various modifications and variations are possible within a scope that does not depart from the technical spirit of the present disclosure described in the claims.

What is claimed is:

1. A secondary battery, comprising:
an electrode assembly in which a positive electrode, a negative electrode and a separator are wound and formed, and which includes a protruding region in which an uncoated portion protrudes and a non-protruding region in which the uncoated portion does not protrude, in an upper portion thereof;
a current collector coupled to the protruding region and electrically connected to the electrode assembly; and
a case accommodating the electrode assembly,
wherein the electrode assembly includes a groove portion formed by bending at least a portion of the protruding region,
wherein the current collector includes a protruding portion inserted into the groove portion, and
wherein the non-protruding region includes an inner non-protruding region disposed further inwardly than the protruding region and an outer non-protruding region disposed further outwardly than the protruding region, in a central direction toward a winding axis along which the electrode assembly is wound.

2. The secondary battery of claim 1, wherein the groove portion is formed by pressing at least a portion of the protruding region in the central direction.

3. The secondary battery of claim 2, wherein a width of the groove portion is formed to decrease toward the center direction.

4. The secondary battery of claim 2, wherein a width of the groove portion is formed to be constant.

5. The secondary battery of claim 1, wherein the electrode assembly has a first hole formed in the center thereof, in which the positive electrode, the negative electrode, and the separator are not disposed.

6. The secondary battery of claim 5, wherein at least a portion of the groove portion is bent and disposed in an upper portion of the inner non-protruding region and is not disposed on the first hole.

7. The secondary battery of claim 5, wherein the current collector includes a plurality of second holes spaced apart from each other in the center.

8. The secondary battery of claim 5, wherein the current collector includes a current collecting pillar protruding from the center.

9. The secondary battery of claim 1, wherein the groove portion and the protruding portion are formed in plural.

10. The secondary battery of claim 1, wherein a width, a difference between an outer diameter and an inner diameter of the inner non-protruding region, is equal to or less than a height of the uncoated portion of the protruding region.

11. A secondary battery manufacturing method, comprising:
a preparation operation of preparing an electrode assembly in which a positive electrode, a negative electrode and a separator are wound and formed, and which includes a protruding region in which an uncoated portion protrudes and a non-protruding region in which the uncoated portion does not protrude, in an upper portion thereof;
a pressing operation of forming a groove portion by bending at least a portion of the protruding region;
an assembling operation of assembling the current collector and the electrode assembly so that the protruding portion of the current collector is inserted into the groove portion; and
a welding operation of welding a region of the protruding portion.

12. The secondary battery manufacturing method of claim 11, wherein the pressing operation is an operation of pressing at least a portion of the protruding region in a central direction toward a winding axis along which the electrode assembly is wound.

13. The secondary battery manufacturing method of claim 11, wherein the welding operation is an operation of welding the current collector by irradiating a laser to an upper portion of the current collector assembled in the assembling operation.
